(19) United States
(12) Patent Application Publication
(10) Pub. No.: US 2024/0099538 A1
(43) Pub. Date: Mar. 28, 2024

(54) CLEANING DEVICE FOR CLEANING MOPPING CLOTH OF SELF-PROPELLED CLEANING APPARATUS

(71) Applicant: Hobot Technology Inc., Chupei City (TW)

(72) Inventors: CHI-MOU CHAO, Zhubei City (TW); Min-Chih Tseng, Zhubei City (TW)

(21) Appl. No.: 18/366,258

(22) Filed: Aug. 7, 2023

(30) Foreign Application Priority Data
Sep. 22, 2022 (CN) CN202211156990.9

(51) Int. Cl. A47L 11/40; A46B 13/00; A46B 13/02; A47L 11/28; B08B 1/00; B08B 1/04; B08B 3/02

(52) U.S. Cl. CPC A47L 11/4091; A46B 13/001; A46B 13/02; A47L 11/28; B08B 1/002; B08B 1/008; B08B 1/04; B08B 3/024; A46B 2200/3033; A47L 2201/028

(57) ABSTRACT

The present invention relates to a cleaning device for cleaning a mopping cloth of a self-propelled cleaning apparatus. The cleaning device includes a clean-water tank, a waste-water tank, a base, a cleaning unit, a clean-water pipeline and a waste-water pipeline. The cleaning unit includes a water outlet, a cleaning brush and a cleaning chamber. The water outlet is configured to spray a cleaning liquid toward a direction away from the base. The cleaning brush cleans a mopping cloth. The clean-water pipeline communicates between the clean-water tank and the water outlet and is for the cleaning liquid in the clean-water tank to pass through the clean-water pipeline and be sprayed from the water outlet. The waste-water pipeline communicates between the waste-water tank and the cleaning chamber of the cleaning unit and is for the cleaning liquid sprayed while the cleaning unit cleans the mopping cloth to pass through the waste-water pipeline and be collected in the waste-water tank.

### CROSS-REFERENCE TO RELATED APPLICATIONS

This application claims priority of No. CN202211156990.9 filed in China on 2022 Sep. 22 under 35 USC 119, the entire content of which is hereby incorporated by reference.

### BACKGROUND OF THE INVENTION

### Field of the Invention

The embodiments of the present invention relate to a cleaning device for a self-propelled cleaning apparatus, and more particularly to a cleaning device for cleaning a mopping cloth of the self-propelled cleaning apparatus.

### Description of the Prior Art

When a currently known sweeping robot performs cleaning, a cleaning function in a wet cleaning mode carried out with water or a cleaning liquid is often used to first wet a mopping cloth or a surface to be cleaned and then perform the cleaning. As such, stains, dust, hair or minute wastes are even more likely to accumulate on the mopping cloth. Thus, after the operation in the wet cleaning mode for a period of time, it is necessary to replace or clean the dirty mopping cloth in order to keep subsequent cleaning effects of the mopping cloth. Although current sweeping robots are capable of automatically cleaning floors, they are incapable of automatically cleaning the mopping cloth, and cleaning or replacement of the mopping cloth can only be performed manually, in a way that the automatic cleaning function without manual intervention of the sweeping robots is greatly degraded. Therefore, there is a need for a novel sweeping robot to solve the drawbacks above.

### SUMMARY OF THE INVENTION

The present invention relates to a cleaning device for cleaning a mopping cloth of a self-propelled cleaning apparatus. The cleaning device includes a clean water tank, a waste-water tank, a base, a cleaning unit, a clean water pipeline and a waste-water pipeline. The clean water tank is for storing a cleaning liquid. The cleaning unit is configured to be movable along a first direction at the base and includes a water outlet, at least one cleaning brush and a cleaning chamber. The water outlet is configured to spray a cleaning liquid toward a direction away from the base. The cleaning chamber exposes at least one portion of the at least one cleaning brush and is for the at least one cleaning brush to clean a mopping cloth. The clean water pipeline communicates between the clean water tank and the water outlet and is for the cleaning liquid in the clean water tank to pass through the clean water pipeline and be sprayed from the water outlet. The waste-water pipeline communicates between the waste-water tank and the cleaning chamber of the cleaning unit, and is for the cleaning liquid sprayed while the cleaning unit cleans the mopping cloth to pass through the waste-water pipeline and be collected in the waste-water tank.

According to some embodiments of the present invention, a bottom and a sidewall of the cleaning chamber form a separation space, which is configured to block the cleaning liquid from flowing out from the bottom or the sidewall of the cleaning chamber.

According to some embodiments of the present invention, the bottom of the cleaning chamber is provided with a drainage hole, which communicates with the waste-water pipeline and is configured to discharge the cleaning liquid.

According to some embodiments of the present invention, the bottom of the cleaning chamber is defined with a recessed space, and the drainage hole is located in the recessed space.

According to some embodiments of the present invention, the drainage hole is located on a lowermost position of the cleaning chamber, the part of the clean water pipeline connected to the water outlet moves along with a movement of the cleaning unit, and the part of the waste-water pipeline connected to the cleaning chamber moves along with the movement of the cleaning unit.

According to some embodiments of the present invention, the bottom of the cleaning chamber further includes at least one side inclined surface and a bottom inclined surface, wherein the at least one side inclined surface and the bottom inclined surface define the recessed space. The bottom inclined surface includes a first side and a second side opposite to the first side, the first side of the bottom inclined surface is connected to the drainage hole, the bottom inclined surface is configured to extend downward from the second side to the first side, and a width of the second side of the bottom inclined surface is greater than a width of the first side.

According to some embodiments of the present invention, the at least one cleaning brush includes at least one roller brush. The at least one roller brush includes a cleaning section and a brush handle for supporting the cleaning section, and at least one portion of the at least one cleaning brush exposed by the cleaning chamber includes the cleaning section. The cleaning unit further includes a drive section, which is configured to drive the at least one roller brush to rotate in a second direction as an axis, wherein the second direction is different from the first direction.

According to some embodiments of the present invention, a ratio of a length of the cleaning section to a length of the at least one roller brush is less than 1:2.

According to some embodiments of the present invention, the drive section includes a first drive element and a second drive element, wherein the first drive element is for moving the cleaning unit along the first direction, and the second drive element is for rotating the at least one roller brush.

According to some embodiments of the present invention, the at least one roller brush includes a first roller brush and a second roller brush, the water outlet is located between the first roller brush and the second roller brush, and the first roller brush and the second roller brush are configured to rotate in opposite rotating directions.

According to some embodiments of the present invention, the bottom of the cleaning chamber further includes a spacer plate. The spacer plate extends upward from a surface of the bottom inclined surface and is for separating the first roller brush and the second roller brush.

According to some embodiments of the present invention, the cleaning device further includes a waste water motor and a rack. The waste-water motor is configured to provide a drive force for the cleaning liquid sprayed while the cleaning unit cleans the mopping cloth to pass through the waste-water pipeline and be collected in the waste-water tank. The rack is arranged on the base and extends along the first direction. The cleaning unit further includes the drive section. The drive section is neighboring to the base and connected to the rack and is configured to move the cleaning unit along the first direction on the rack.

According to some embodiments of the present invention, the cleaning device further includes the waste-water motor. The waste-water motor communicates with the waste-water tank and is for forming a negative pressure in the waste-water tank and hence for the cleaning liquid sprayed while the cleaning unit cleans the mopping cloth to pass through the waste-water pipeline and be collected in the waste-water tank.

According to the above arrangement of the cleaning unit of the present invention, a used and dirty mopping cloth can be effectively automatically cleaned, and most of dust on the dirty mopping cloth falls into the cleaning chamber along with the cleaning liquid and is drawn into the waste-water tank through the waste-water pipeline instead of falling onto the base of the cleaning device. Thus, dust can be prevented from accumulating on the base and the need for cleaning of the base of the cleaning device can be alleviated, hence greatly reducing manual intervention and thereby enhancing ease of use of the cleaning unit.

### BRIEF DESCRIPTION OF THE DRAWINGS

Aspects of the present disclosure can be better understood by reading the following embodiments in combination with the accompanying drawings below. It should be noted that, the structures are not drawn to actual scales according to a standard practice of industry. In fact, for description clarity, the sizes of the various structures may be upscaled or downscaled as desired. It should be noted that the accompanying drawings in the description below provide merely some embodiments of the present disclosure, and a person skilled in the art could arrive at other accompanying drawings on the basis of these accompanying drawings without involving any inventive skill.

FIG. 1A is a perspective diagram and a bottom view of a self-propelled cleaning apparatus according to an embodiment of the present invention.

FIG. 1B is a bottom view of a self-propelled cleaning apparatus according to an embodiment of the present invention.

FIG. 2A is a perspective diagram of a cleaning device according to an embodiment of the present invention.

FIG. 2B is another perspective diagram of a cleaning device according to an embodiment of the present invention.

FIG. 3 is an exploded view of a cleaning unit according to an embodiment of the present invention.

FIG. 4 is a perspective diagram of a cleaning chamber according to an embodiment of the present invention.

FIG. 5 is a side view of a base of a lower seat and a cleaning unit according to an embodiment of the present invention.

FIG. 6 is a perspective diagram of a base, a cleaning unit and a mopping cloth according to an embodiment of the present invention.

FIG. 7 is a perspective diagram of a cleaning unit without an upper cover according to an embodiment of the present invention.

FIG. 8 is a perspective diagram of a cleaning unit according to an embodiment of the present invention.

### DETAILED DESCRIPTION OF THE EMBODIMENTS

The disclosure below provides various different embodiments or examples of different components used to implement the subject matter of the disclosure. Specific examples of components and configurations are given in the description below to simplify the disclosure. It should be noted that these components and configurations are exemplary and are not to be intended to be restrictive. For example, in the description below, a first component formed on or above a second component may include an embodiment in which the first component and the second component are formed in a direct contact manner, and may also include an embodiment in which an additional component is formed between the first component and the second component in a way that the first component and the second component may not be in direct contact. Moreover, reference numerals and/or alphabetical symbols may be repeated in the various embodiments of the disclosure. Such repetition is intended for simplicity and clarity and does not represent relations between the embodiments and/or configurations.

Further, for better description, relative spatial terms such as “below”, “under”, “underneath”, “above”, “on”, and “over” and the like may be used to describe the relation between one element or component and other element(s) or component(s) as given in the drawings. In addition to the orientation depicted in the drawings, the relative spatial terms are also intended to cover different orientations of a device in use or operation. An apparatus may be orientated by other means (rotated by 90 degrees or having another orientation).

The present invention relates to a cleaning device for a self-propelled cleaning apparatus. After the self-propelled cleaning apparatus executes a cleaning program by using its mopping cloth, an automatic cleaning function provided by the cleaning device of the present invention is capable of restoring the dirty mopping cloth to an original clean state, allowing the self-propelled cleaning apparatus to continue cleaning tasks, hence achieving a complete cleaning program without any manual intervention and greatly enhancing utilization experience for a user.

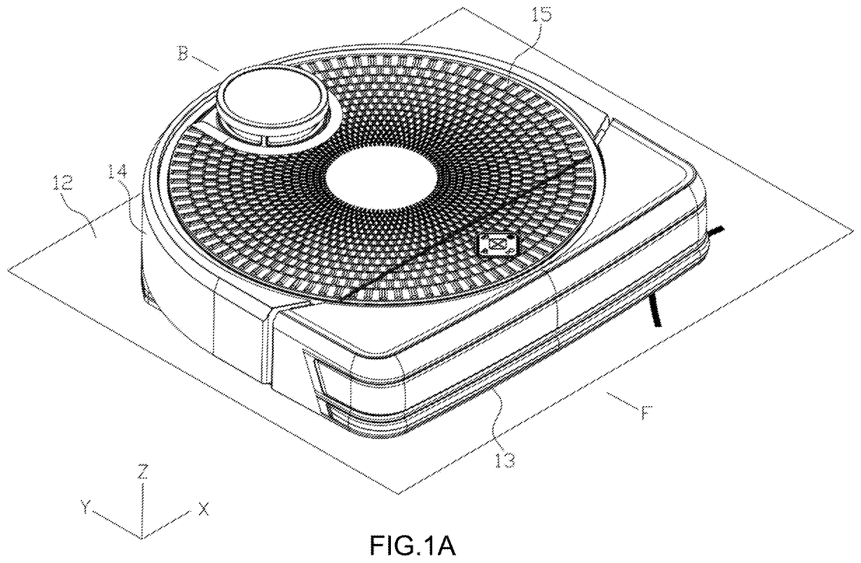

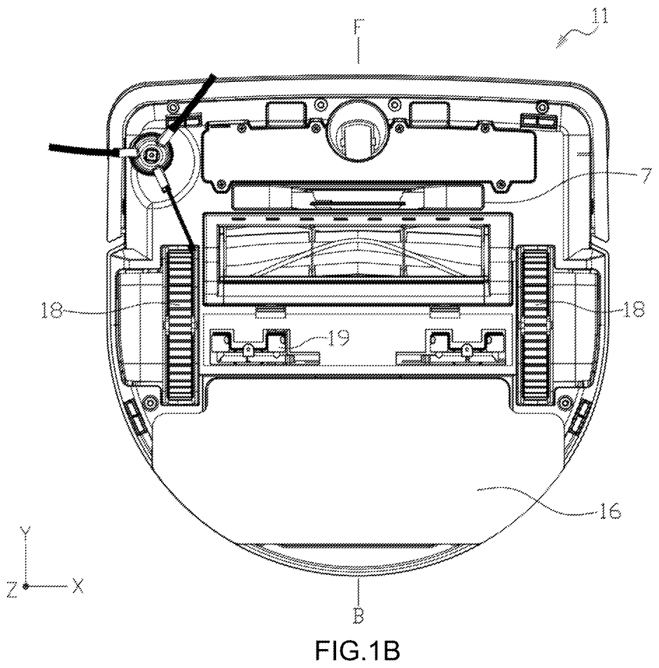

FIG. 1A and FIG. 1B show a perspective diagram and a bottom view of a self-propelled cleaning apparatus according to an embodiment of the present invention, respectively. The self-propelled cleaning apparatus 11 may be used to clean a common floor or a surface 12 having a large area, for example, a performance stage, a large-area desk or a working platform, and may be in different forms such as a toy, a remote-controlled car or a robot. The self-propelled cleaning apparatus 11 performs cleaning while moving on the surface 12 in contact therewith, and achieves the object of cleaning the surface 12 by means of moving back and forth on the surface 12. In the literature, the self-propelled cleaning apparatus 11 is exemplified by a floor-cleaning robot for illustrations; however, the present invention is not limited to such example of a floor-cleaning robot.

Referring to FIG. 1A, self-propelled cleaning apparatus 11 includes a bumper 13, a casing 14 and an upper cover 15. The self-propelled cleaning apparatus 11 can freely move in different directions on the surface 12 to be cleaned. For illustration purposes, in the present literature, the self-propelled cleaning apparatus 11 can move in a forward movement direction F and a backward movement direction B. The bumper 13 faces the forward movement direction F and serves as a front side of the self-propelled cleaning apparatus 11, and has a flat and straight appearance. The casing 14 faces the backward movement direction B and serves as a back side of the self-propelled cleaning apparatus 11, and has an arc appearance. Referring to FIG. 1B, the self-propelled cleaning apparatus 11 further includes various components, for example, a suction port 7, a roller brush device 17, a walking unit 18 and a water spray device 19. In one embodiment, the self-propelled cleaning apparatus 11 has a cleaning cloth seat located on a rear bottom of the self-propelled cleaning apparatus 11. The cleaning cloth seat usually has a flat surface for a mopping cloth 16 to be readily adhered or attached onto the cleaning cloth seat to perform cleaning. In one embodiment, the mopping cloth 16 is located on a position of the self-propelled cleaning apparatus 11 close to the back. The components of the self-propelled cleaning apparatus 11 described above are merely examples, and these components may be omitted or other components may be added in other different embodiments of the self-propelled cleaning apparatus 11.

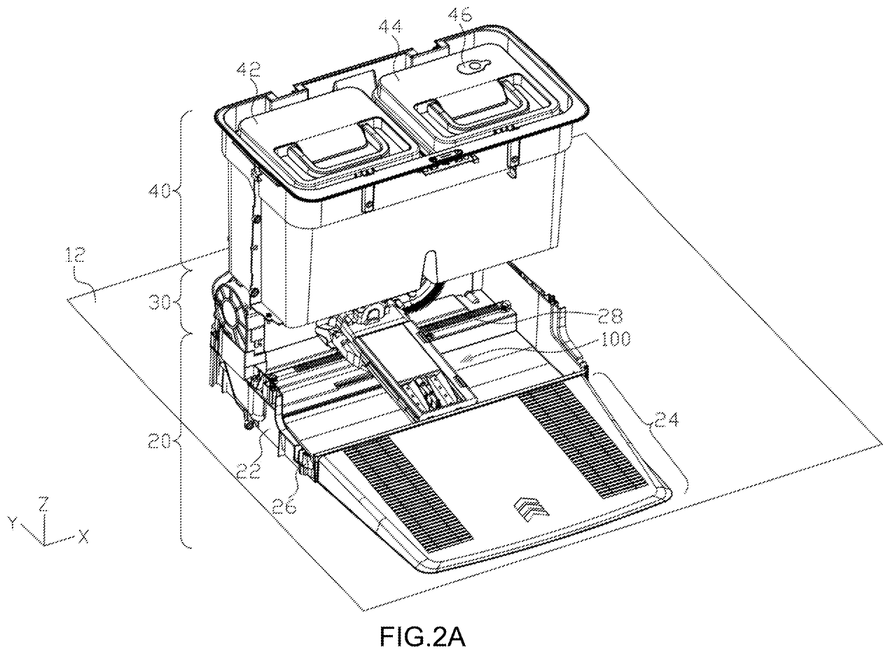

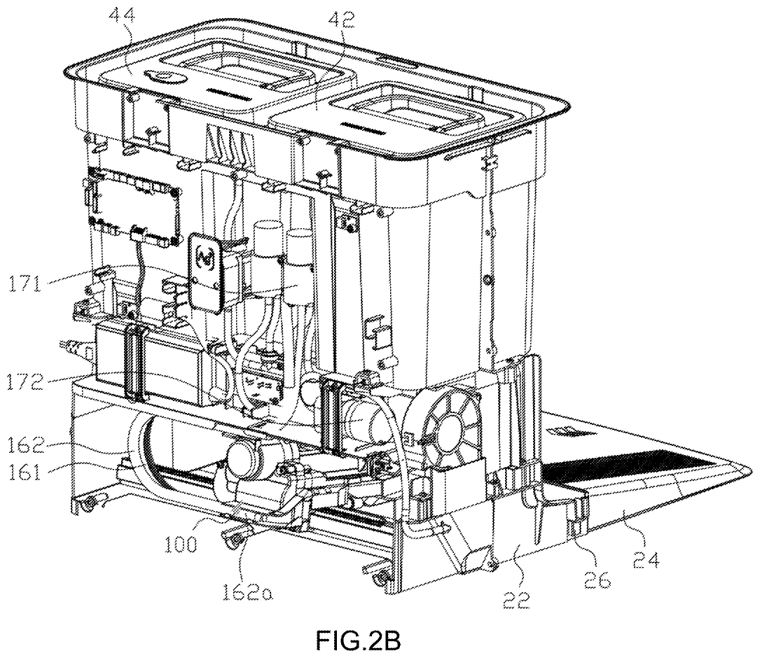

FIG. 2A shows a perspective diagram of a cleaning device 10 according to an embodiment of the present invention. In some embodiments, the cleaning device 10 is not directly used to clean the surface 12, but is used to clean the mopping cloth 16 of the self-propelled cleaning apparatus 11. In one embodiment, the cleaning device 10 may serve as a docking station of the self-propelled cleaning apparatus 11, so that the self-propelled cleaning apparatus 11 can perform different steps at the docking station where the cleaning device 10 is located, for example, docking to cease operation, charge, clean a dust box and cleaning the mopping cloth 16. The various steps above may be performed at different timings or be performed concurrently.

In one embodiment, the cleaning device 10 includes a lower seat 20, a middle seat 30 and a water tank seat 40. In one embodiment, the lower seat 20 includes a base 22, a guide plate 24, a fastener 26, a rack 28 and a cleaning unit 100. In one embodiment, the middle seat 30 is provided with components such as a charging electrode (not shown), an alignment unit (not shown), a signal transmission unit (not shown), a signal reception unit (not shown) and a distance detector (not shown). In one embodiment, the water tank seat 40 has an internal space for accommodating a waste-water tank 42 and a clean-water tank 44. The clean-water tank 44 is provided with a ventilation hole to balance the air pressure in the clean-water tank 44 and the ambient air pressure. In one embodiment, the clean-water tank 44 is provided with a ventilation hole cover 46 to cover the ventilation hole, and is provided with a slit to allow air to pass through. The ventilation hole cover 46 may be made of an elastic material, so that the slit is kept closed when the air pressure inside and outside the clean-water tank is balanced, and the slit is opened due to a pressure difference between imbalanced air pressures so as to allow air to pass through. In one embodiment, the waste-water tank 42 is provided with a water level detector. When a water level of the waste-water 42 reaches a predetermined height, the cleaning device 10 may issue a prompt signal to prompt the user to empty the waste-water tank 42. As such, waste water is prevented from contaminating the ambient environment of the cleaning device 10, and the frequency at which the user disposes waste water can also be reduced.

Referring to FIG. 1A, FIG. 1B and FIG. 2A, in one embodiment, when the self-propelled cleaning apparatus 11 is to return to the cleaning device 10 as it determines or due to other mandatory reasons (for example, for charging, due to a full dust box, or being recalled), a guide signal is sent by the signal transmission unit. With the guide signal and the assistance of the alignment unit, the self-propelled cleaning apparatus 11 then moves along the first direction (for example, an X-axis direction) to align with the cleaning device 10. Next, the self-propelled cleaning apparatus 11 moves along the guide plate 24 toward the lower seat 20 (for example, along a Y-axis direction) until the self-propelled cleaning apparatus 11 reaches a predetermined position or is distanced by a predetermined distance and stops, for example, a battery electrode of the self-propelled cleaning apparatus 11 comes into contact with a charging electrode of the middle seat 30 or docked with an alignment latch. In one embodiment, with the movement of the self-propelled cleaning apparatus 11, the mopping cloth 16 moves to above the cleaning unit 100 on the base 22. In one embodiment, the self-propelled cleaning apparatus 11 may simultaneously perform the steps of charging and cleaning the mopping cloth 16 by using the cleaning unit 100. In other embodiments, the self-propelled cleaning apparatus 11 performs the steps of charging and cleaning the mopping cloth 16 at different timings.

In one embodiment, the rack 28 is arranged on the base 22 and extends along the X-axis direction. Teeth of the rack 28 extends along the Y-axis direction and are arranged in parallel. In one embodiment, the cleaning unit 10 is connected to the rack 28 and moves back and forth along the X-axis direction. Thus, the mopping cloth 16 is moved in the Y-axis direction to right above the position of the cleaning unit 100, enabling the cleaning unit 100 to move back and forth along the X-axis direction in an internal space of the base 22 and to use the roller brush to clean the mopping cloth 16.

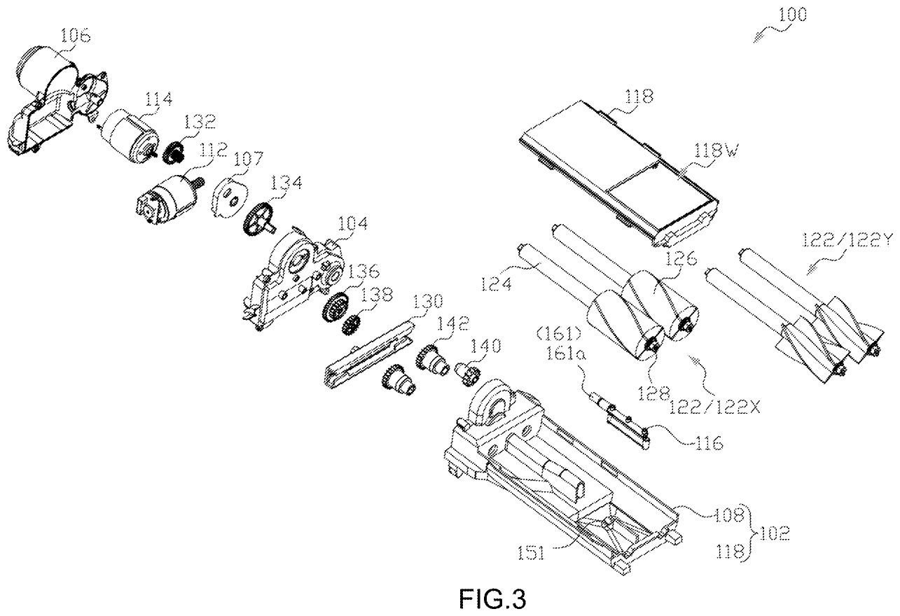

FIG. 3 shows an exploded view of the cleaning unit 100 according to an embodiment of the present invention. In one embodiment, the cleaning unit 100 includes a cleaning chamber 102 (including a shell 108 and an upper cover 118), a motor front cover member 104, a motor back cover member 106 and a spacer 107 to form a housing for accommodating various elements of the cleaning unit 100. In one embodiment, the cleaning unit 100 includes the following elements: a movement motor 112, a rotation motor 114, a water outlet 116, a roller brush 122, a slide block 130 and a gear 134, a gear 136, a gear 138, a gear 140 and a gear 142. In one embodiment, the roller brush 122 includes a brush handle 124, a cleaning section 126 and a fixed section 128. The roller brush 122 may be categorized into a brush-type roller brush 122X or a scraper-type roller brush 122Y according to different structures of the cleaning section 126. In one embodiment, the brush-type roller brush 122X is provided with bristles on a roller of the cleaning section 126, wherein the bristles are regularly arranged and extend radially outward from a surface of the roller of the cleaning section 126. In one embodiment, the scraper-type roller brush 122Y is provided with a scraper on the roller of the cleaning section 126, wherein the scraper extends spirally outward along the surface of the cleaning section. The functions and connections of other components of the cleaning unit 100 are to be described with the accompanying drawings below. In one embodiment, the roller brush 122 may also be replaced by a cleaning brush capable of cleaning the mopping cloth 16; for example, a cleaning brush such as a vibrating brush or a moving brush may be used.

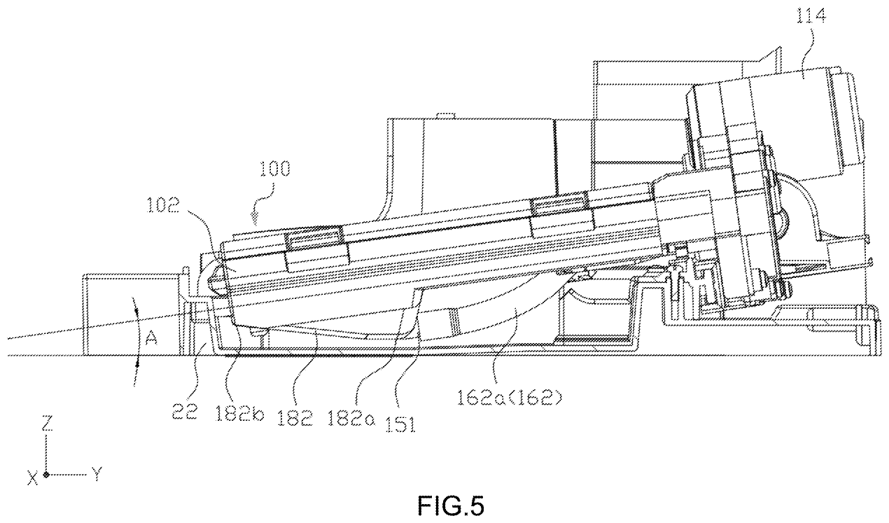

Referring to FIG. 2B, FIG. 3 and FIG. 5, the cleaning unit 100 further includes a clean-water pipeline 161 and a waste-water pipeline 162. The clean-water pipeline 161 communicates between the clean-water tank 44 and the water outlet 116, and is for the cleaning liquid in the clean-water tank 44 to pass through the clean-water pipeline 161 and be sprayed from the water outlet 116. The waste-water pipeline 162 communicates between the waste-water tank 42 and the cleaning chamber 102, and is for the cleaning liquid sprayed while the cleaning unit 100 cleans the mopping cloth 16 to pass through the waste-water pipeline 162 and be collected in the waste-water tank 42.

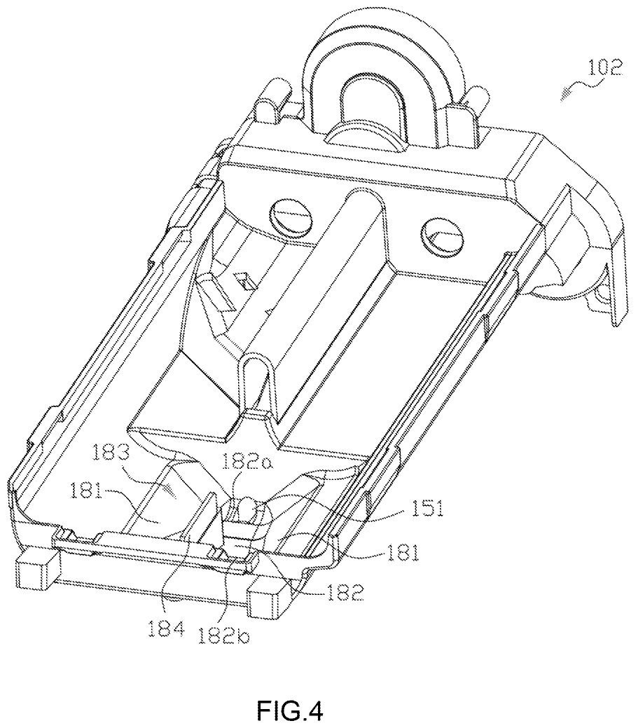

The bottom of the chamber body 108 of the cleaning chamber 102 is provided with a drainage hole 151, which communicates with the waste-water pipeline 162 and is configured to discharge the cleaning liquid. Referring to FIG. 4, the bottom of the chamber body 108 further includes two side inclined surfaces 181 and a bottom inclined surface 182, wherein the bottom inclined surface 182 is connected between bottom sides of the two side inclined surfaces 181. Moreover, the two side inclined surfaces 181 and the bottom inclined surface 182 define a recessed space 183, the drainage hole 151 is located in the recessed space 183, and the recessed space 183 is similar to a cone and is configured to guide the cleaning liquid to flow into the drainage hole 151. The bottom inclined surface 182 includes a first side 182a and a second side 182b opposite to the first side 182a, wherein the first side 182a of the bottom inclined surface 182 is connected to the drainage hole 151. The bottom inclined surface 182 is configured to extend downward from the second side 182b to the first side 182a and has a gradually decreasing width, such that the width of the second side 182b of the bottom inclined surface 182 is greater than the width of the first side 182a, for the cleaning liquid to adaptively flow down to the drainage hole 151. In one embodiment, the bottom of the chamber body 108 further includes a spacer plate 184. The spacer plate 184 extends upward from a surface of the bottom inclined surface 182 and is for separating the two roller brushes 122. Referring to FIG. 5, the drainage hole 151 is located on a lowermost position of the cleaning chamber 102, and more specifically, the part of the cleaning chamber 102 closest to the ground or to the bottom of the base 22 is the drainage hole 151.

FIG. 2B shows another perspective diagram of a cleaning device according to an embodiment of the present invention. FIG. 2B is a perspective diagram viewed from the back of the cleaning device 10 and clearly shows internal components of the cleaning device 10. In one embodiment, a connection section 161a of the clean-water pipeline 161 connected to the water outlet 116 moves along with the movement of the cleaning unit 101, and a connection section 162a of the waste-water pipeline 162 connected to the cleaning chamber 102 moves along with the movement of the cleaning unit 101.

Referring to FIG. 2B, the cleaning device 10 further includes a clean-water motor 171 and a waste-water motor 172. The waste-water motor 172 communicates with the waste-water tank 42 and is configured to form a negative pressure in the waste-water tank 42, such that the cleaning liquid sprayed while the cleaning unit 101 cleans the mopping cloth 16 passes through the waste-water pipeline 162 and is collected in the waste-water tank 42. The clean-water motor 171 communicates with the clean-water tank 44 and the water outlet 116 and is configured to drive the cleaning liquid to be sprayed from the water outlet 116. In one embodiment, an enclosed space formed by the bottom and the sidewall of the chamber body 108 may be used as a water collection structure capable of blocking the cleaning liquid from flowing out from the bottom or the sidewall of the chamber body 108 and further preventing spillage of the cleaning liquid. Thus, the cleaning liquid carrying dust in the mopping cloth 16 flows into the recessed space 183, and the cleaning liquid carrying dust passes through the drainage hole 151 and the waste-water pipeline 162 and is collected in the waste-water tank 42 instead of residing on the bottom surface of the base 22.

According to the prior art, once the cleaning liquid flows into the water collection tank of the base 22, waste water is drawn from the water collection tank of the base 22 into the waste-water tank 42. Since the bottom surface of the water collection tank of the base 22 is flat and the flow speed of water is slow, dust or dirt is likely to be accumulated on the bottom surface of the water collection tank. However, according to the present invention, the cleaning liquid carrying dirt is directly drawn from the cleaning chamber 102, preventing dust or dirt from being easily accumulated on the bottom surface of the water collection tank of the base 22. In one embodiment, the drainage hole 151 is on the lowermost position of the cleaning chamber 102, such that the cleaning liquid carrying dust or dirt is allowed to flow to the drainage hole 151 and eventually be collected in the waste-water tank 42. In one embodiment, the cleaning chamber 102 further has the recessed space 183 formed therein, allowing the cleaning liquid carrying dust or dirt to even more easily flow into the recessed space 183. The recessed space 183 is capable of guiding the cleaning liquid carrying dust or dirt to flow to the drainage hole 151 and eventually be collected in the waste-water tank 42. In one embodiment, the bottom and the sidewall of the chamber body 108 form an enclosed space as a water collection structure, and are capable of blocking the cleaning liquid from flowing out from the bottom or the sidewall of the chamber body 108 and hence preventing spillage of the cleaning liquid, so that dust or dirt accumulated on the bottom surface of the base 22 can be reduced. In addition, the base 22 is not required to be provided with a water collection tank, and no pipeline is needed for communicating the water collection tank and the waste-water tank 42 or drawing waste water from the water collection tank to the waste-water tank 42. In one embodiment, the waste-water pipeline 162 is connected to the cleaning chamber 102, and waste water is directly drawn into the waste-water tank 42 by using the waste-water motor 172. Thus, an additional draining valve for periodically allowing the cleaning liquid to flow into the water collection tank of the base 22 is not needed.

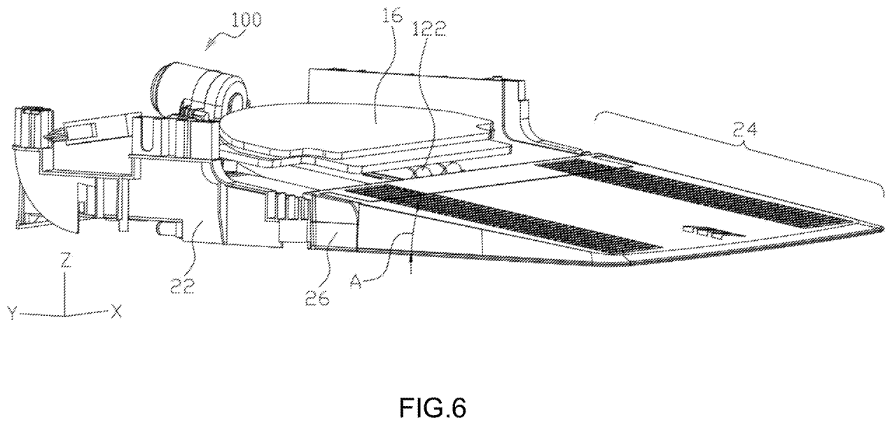

Referring to FIG. 1A, FIG. 1B, FIG. 3 and FIG. 6, a weight of the self-propelled cleaning apparatus 11 presses the cleaning section 126 of the roller brush 122 downward via the mopping cloth 16, such that the mopping cloth 16 is closely in contact with the cleaning section 126. With the contact and friction between the cleaning section 126 and the mopping cloth 16 as well as washing of the cleaning liquid, dust and waste on the mopping cloth 16 can be scraped off from a surface or an inside of the mopping cloth 16. In one embodiment, the brush handle 124 of the roller brush 122 is located in the cleaning chamber 102 and fixed on one side of the cleaning unit 100, and securely supports the cleaning section 126. By rotating the brush handle 124, the cleaning section 126 is rotated to as to generate a scraping force in a tangential direction of the surface of the mopping cloth 16. Thus, cleaning ability of the cleaning section 126 is determined by downward pressure of the self-propelled cleaning apparatus 11, rotational force of the roller brush 122 and an assistive effect provided by the cleaning liquid and the bristles (or the scraper).

In one embodiment, the brush handle 124 is fundamentally formed of a material without any extensibility or with extremely small extensibility. In one embodiment, a length of the cleaning section 126 occupies only a part of the roller brush 122 so as to keep cleaning force concentrated. In one embodiment, a ratio of the length of the cleaning section 126 to a length of the roller brush 122 is substantially lower than 1:2, for example, between 1:4 and 1:2, or between 1:3 and 1:2. Thus, when the cleaning unit 100 is to clean different parts of the mopping cloth 16 along the Y-axis direction, the object of moving the cleaning section 126 cannot be achieved by means of extension of the brush handle 124. Instead, the self-propelled cleaning apparatus 11 is moved on the Y-axis to generate a change in relative positions of the mopping cloth 16 and the cleaning section 126, enabling the cleaning unit 100 to come into contact with different parts of the mopping cloth 16 on the Y-axis.

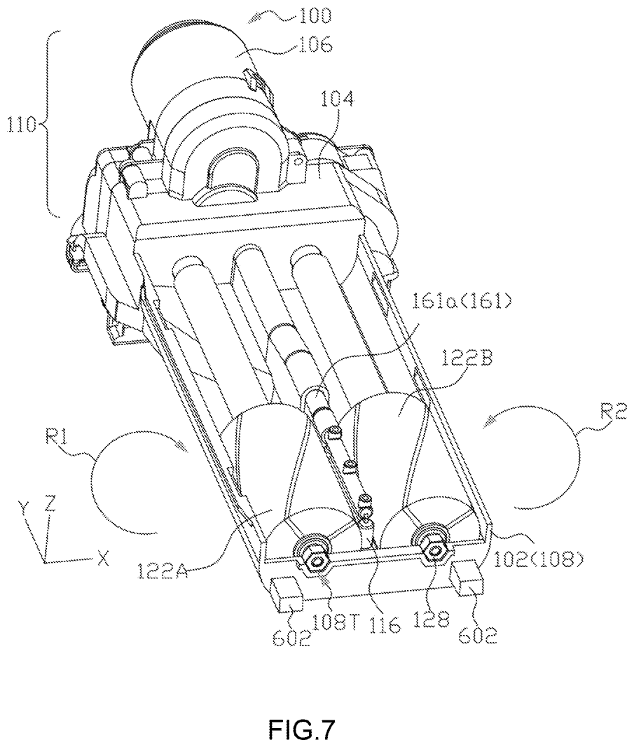

FIG. 7 shows a perspective diagram of the cleaning unit 100 according to an embodiment of the present invention. Referring to FIG. 7, the cleaning unit 100 is provided with the cleaning chamber 102 for accommodating the roller brush 122 and the water outlet 116. In one embodiment, the water outlet 116 is located in the middle of the roller brush 122A and the roller brush 122B and includes one or more nozzles arranged along the Y-axis direction. In one embodiment, the nozzle of the water outlet 116 faces the side of the mopping cloth 16 to spray the cleaning liquid toward the mopping cloth 16. In one embodiment, the nozzle of the water outlet 116 sprays the cleaning liquid in a direction away from the base.

Referring to FIG. 3, the drive section 110 of the cleaning unit 100 is neighboring to the base 22 and is located above the rack 28. The drive section 110 is connected to the rack 28 and the roller brush 122 and is configured to generate a drive force to move the cleaning unit 100 or to rotate the roller brush 122. In one embodiment, the drive section 110 is primarily divided into a first drive element 210 and a second drive element 220. First of all, the first drive element 210 (also referring to as a movement component) includes a movement motor 112, the gear 132, the gear 134 and the gear 140, generates a drive force via the movement motor 112, and transmits the drive force to the gear 140 via the gear 132 and the gear 134, such that the gear 140 drives the cleaning unit 100 to move back and forth in a linear manner along the X-axis direction on the rack 28. On the other hand, the second drive element 220 (also referred to as a rotation element) includes a rotation motor 114, the gear 136, the gear 138 and the gear 142, generates a drive force via the rotation motor 114, and transmits the drive force to the gear 142 via the gear 136 and the gear 138, such that the gear 142 drives the brush handle 124 (as shown in FIG. 3 and FIG. 7) of each roller brush 122 to rotate around an axis of the brush handle 124. In one embodiment, the roller brush 122A and the roller brush 122B are parallel to each other and extend in the Y-axis direction. In one embodiment, the roller brush 122A and the roller brush 122B are located on a same plane and are in close contact with the mopping cloth 16.

In one embodiment, the cleaning device 10 or the cleaning unit 100 is provided with a controller (not shown), which forms a predetermined control signal by a control circuit, and output powers of the movement motor 112 and the rotation motor 114 are respectively determined by controlling a voltage or controlling a current, further respectively determining a movement speed or a stop position of the cleaning unit 100 on the rack 28 as well as rotation speed of the roller brush 122A and the roller brush 122B. Since the movement motor 112 and the rotation motor 114 operate independently from each other, output power of the two are also independent from each other. Thus, the movement speed of the cleaning unit 100 and the rotation speed of the roller bush 122 are also independent from each other.

Compared to a cleaning device operating with one single motor, since only one output power can be selected as the output power of the single motor at a time, optimization or adjustment made on the movement speed of the cleaning unit or the rotation speed of the roller brush presents an effect of concurrent acceleration or concurrent deceleration, that is, individually customized optimization designs for movement and rotation cannot be fulfilled at the same time. In contrast, the dual motor drive design of the present invention is capable of providing individually customized optimization design for movement and rotation, hence achieving better cleaning effects. In one embodiment, the roller brush 112A and the roller brush 112B are driven by a same rotation motor 114, and so the rotation speed of the roller brush 112A and the roller brush 112B are dependent on each other. In one embodiment, the roller brush 122A and the roller brush 122B have the same rotation speed but rotate in opposite directions. In some embodiments, the roller brush 122A and the roller brush 122B can rotate in a clockwise or counterclockwise direction.

In one embodiment, the cleaning chamber 102 includes the chamber body 108 and the upper cover 118 (as shown in FIG. 3). The upper cover 118 is pivotally connected to the chamber body 108, and can open or close to facilitate cleaning or replacement of the roller brush 122. In one embodiment, the upper cover 118 is provided with an opening 118W, allowing the roller brush 122 to be exposed from the opening 118W and come into contact with the mopping cloth 16. In one embodiment, when a cleaning task by the mopping cloth 16 is performed, the mopping cloth 16 comes into contact with the roller brush 122 from above the roller brush 122, the upper cover 118 is in a closed state to form along with the chamber body 102 a water collection space, and the mopping cloth 16 also covers above the opening 118W. As such, side surfaces of the water outlet 116 are surrounded by the roller brush 122A, the roller brush 122B and the cleaning chamber 102 (preferably surrounded by the chamber body 108 and the upper cover 118), and the water outlet 116 is covered by the mopping cloth 16 from above. When the cleaning liquid is sprayed from the water outlet 116 toward the top of the opening 118W (that is, a direction facing the mopping cloth 16), the cleaning section 126 rotates in opposite directions R1 and R2 so as to produce friction against the mopping cloth 16. In one embodiment, the upper cover 118 of the cleaning chamber 102 abuts against the mopping cloth 16, and is among the roller brush 122A, the roller brush 122B, the water outlet 116 and the opening 118W. Thus, the upper cover 118 and the mopping cloth 16 form an approximately enclosed space to clean the part of the mopping cloth 16 exposed at the opening 118W. In one embodiment, outer sides of respective second ends of the roller brush 122A and the roller brush 122B are enveloped by the cleaning chamber 102 and are connected to the cleaning chamber 102 via the fixed section 128, and are not directly driven by the first drive element 210 or the second drive element 220. Moreover, a front of the chamber body 108 of the cleaning chamber 102 separates the fixed section 128 from the sidewall of the base 22.

In one embodiment, the cleanings section 126 rotates in opposite directions R1 and R2, that is, parts that expose the upper cover 118 and close to the mopping cloth 16 rotate toward a direction of the water outlet 116, respectively. In one embodiment, one side of the cleaning section 126 close to the water outlet 116 rotates in a direction facing the base 22. In one embodiment, the roller brush 122A and the roller brush 122B, apart from achieving the object of cleaning the mopping cloth 16 by using the rotation of the cleaning section 126, are both located on opposite sides of the water outlet 116, and can thus serve as block walls for each other when a cleaning task is performed so as to block the cleaning liquid from the other side, such that most of the cleaning liquid can be blocked when pushed toward outer regions of the cleaning chamber 102. In one embodiment, since the enclosed space provided by the cleaning chamber 102 enables the cleaning liquid to be rolled up by the roller brush 122 and carried to the mopping cloth 16, the proportion of recycling and reusing the cleaning liquid is increased. Thus, in addition to doubling cleaning efficiency, the design of the dual roller brush further provides the cleaning chamber 102 with assistance to block the thrown cleaning liquid or to push the cleaning liquid toward a center region of the cleaning chamber 102 instead of toward an outer region of the cleaning chamber 102, hence optimizing a cleaning effect of the cleaning liquid as well as maximizing an effect of waste water collection.

In one embodiment, the scraper provided at the cleaning section 126 generates friction against the mopping cloth 16 while it moves along the first direction and scrapes off dust or waste on the mopping cloth 16. In one embodiment, when the drive section 110 drives the roller brush 122 to perform a cleaning task along the X-axis direction, the roller brush 122 may rotate clockwise, rotate counterclockwise or be still according to requirements. When the roller brush 122 is still, the cleaning unit relies on the movement of the roller brush 122 along the X-axis direction to generate friction against the mopping cloth 16.

FIG. 5 shows a side view of a base of a lower seat and a cleaning unit according to an embodiment of the present invention. FIG. 6 shows a perspective diagram of a base, a cleaning unit and a mopping cloth according to an embodiment of the present invention.

Referring to FIG. 5 and FIG. 6, the cleaning unit 100 is arranged at the bottom of the base 22, and is configured to clean a surface of the mopping cloth 16 facing one side (for example, a lower side) of a surface to be cleaned (for example, the ground) from below the mopping cloth 16. Thus, a platform at the bottom of an entire base 22 needs to be lifted in order to accommodate the cleaning unit 100. In one embodiment, the guide plate 24 (referring to FIG. 6) needs to guide the self-propelled cleaning apparatus 11 to return to the base 22 of the cleaning device 10 from a surface 12 to be cleaned (for example, the ground). Thus, the surface of the guide plate 24 is an inclined surface and forms an included angle A relative to the bottom of the base 22 or the surface 12 to be cleaned, and the guide plate 24 is connected to the front of the base 22 by a fastener 26, allowing the walking device (for example, a moving wheel) of the self-propelled cleaning apparatus 11 to move to the platform at the bottom of the base 22. In one embodiment, the first angle A is between 5 degrees and 30 degrees. In one embodiment, the mopping cloth 16 is parallel to the upper cover 118 of the cleaning chamber 102, such that the roller brush 122 and the mopping cloth 16 can constantly keep the mopping cloth 16 closely connected to the cleaning section 126 when respectively moving along the X-axis direction and the Y-axis direction to perform a cleaning task, hence ensuring a cleaning effect and reducing spillage of waste water to the outside.

The rack 28 is fixed at the bottom of the base 22, and the cleaning unit 100 is fastened on a slide rail of the rack 28 by means of the slide block 130. It is observed from FIG. 5 that, in side view, the slide rail and the slide block 130 are inclined toward the guide plate 24 by the included angle A, such that the housing of the cleaning unit 100 also inclined downward by the included angle A, and the cleaning chamber 102 faces the guide plate 24 and is kept in a downward inclined state by the angle A. Referring to FIG. 6, in one embodiment, both of the cleaning unit 100 and the guide plate 24 are kept with the same included angle A and are joined to form a continuous inclined surface, such that the self-propelled cleaning apparatus 11 persistently exhibits the same included angle A when it moves inward from the outside of the guide plate 24 to above the cleaning unit 100. As such, regardless of the relative positions of the mopping cloth 16 and the cleaning unit 100, it is ensured that the cleaning chamber 102 and the mopping cloth 16 are constantly kept in a parallel and close-contact state to maintain a cleaning effect of the roller brush 122.

In one embodiment, the cleaning unit 100 is provided with a water pump motor (not shown) serving as the waste-water motor 172 and a pipeline connected to the waste-water tank 42, and waste water collected by the cleaning chamber 102 is transported to the waste-water tank 42 by using a drive force provided by the water pump motor serving as the waste-water motor 172 through the drainage hole and the pipeline.

In one embodiment, referring to FIG. 3, the cleaning unit 100 drives the gear 140 by the movement motor 112. Then, the cleaning unit 100 is driven to move along the X-axis direction by means of engagement between the gear 140 and multiple teeth of the rack 28, fixed on slide block 130 by the motor front cover member 104, and then driven to slide along the X-axis direction by the slide rail (not shown) fastened by the slide block 130 on the base 22. In one embodiment, most of the weight of the cleaning unit 100 is carried by a combination of the slide block 130 and the base 22 in a way that a function of the gear 140 is simplified. That is, the cleaning unit 100 is driven to move along the X-axis direction by means of the engagement between the gear 140 and multiple teeth of the rack 28, so that the gear 140 is not required to carry all of the weight of the cleaning unit 100.

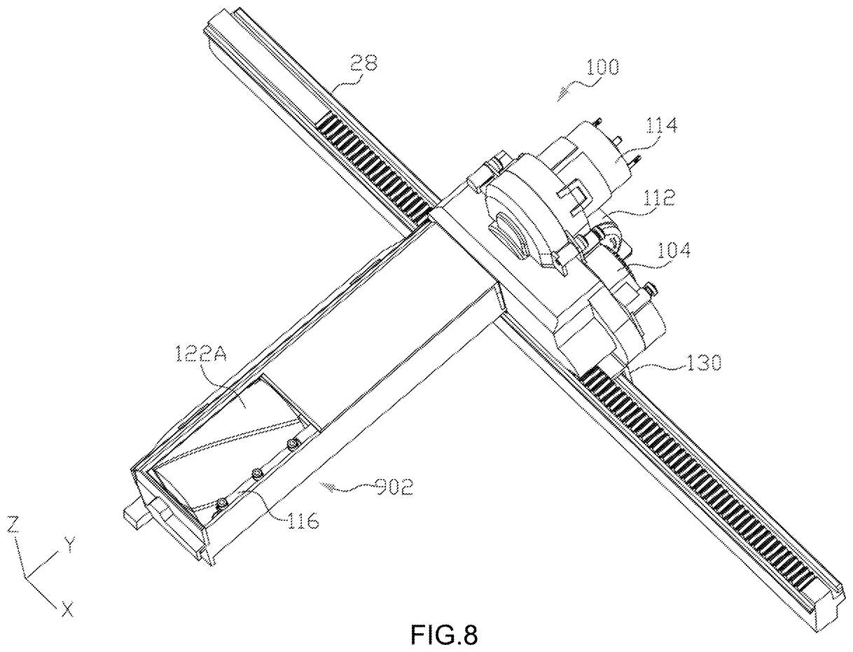

Referring to FIG. 2A, FIG. 3 and FIG. 8, in one embodiment, the base 22 is only provided with the rack 28 on one side for the cleaning unit 100 to move on the base 22. As such, the roller 122 can only be connected to the drive section 110 of the cleaning unit 100 from the first end of the brush handle 124 via the gear 142, and the second end of the roller brush 122 leans on a groove 108T on a front sidewall of the cleaning chamber 102 via the fixed section 128. In other words, the roller brush 122 is driven from one side by the drive section 110. In one embodiment, the roller brush 122 of the cleaning unit 100 on the side of the cleaning section 126 is suspended and is enveloped by the cleaning chamber 102, with no other drive element or rail being provided to rotate or move the roller brush on the side of the cleaning section 126.

FIG. 8 shows a perspective diagram of the cleaning unit 101 according to an embodiment of the present invention. A cleaning unit 101 is in many ways similar to the cleaning unit 100 described above, and details of these similarities are omitted herein. The cleaning unit 101 differs from the cleaning unit 100 in that, the cleaning unit 101 is provided with only one roller brush 122A accommodated in a cleaning chamber 902. Although the water outlet 116 is not provided with the other roller brush 122B on the side opposite to the roller brush 122A as a tool for cleaning the mopping cloth 16, an advantage of reducing an area of the cleaning unit is achieved. Moreover, the cleaning chamber 902, similar to the cleaning chamber 102, effectively envelops the roller brush 122A and the water outlet 116, so spillage of waste water can still be ideally controlled. In one embodiment, the cleaning chamber 902 has a chamber body and an upper cover (similar to the upper cover 118, not shown in FIG. 8), wherein the upper cover covers the brush handle 124 and has an opening to expose the water outlet 116 and the cleaning section 126. In one embodiment, the upper cover covers all or at least a part of the brush handle 124. In one embodiment, a sidewall of the chamber body of the cleaning chamber 902 on the side close to the roller brush 122A and a sidewall on the side close to the water outlet 116 may have different configurations; for example, the sidewall on the side close to the water outlet 116 is higher so as to effectively block spillage of the cleaning liquid sprayed from the water outlet.

In conclusion, according to an embodiment of the present invention, the waste-water pipeline 162 communicates between the waste-water tank 42 and the cleaning chamber 102 of the cleaning unit 101, such that the cleaning liquid carrying dust or dirt in the mopping cloth 16 passes through the drainage hole 151 and the waste-water pipeline 162, and is collected in the waste-water tank 42. Thus, once the cleaning liquid flows into the base 22, the problem that dust or dirt is likely to be accumulated on the bottom surface of the water collection tank as a result of the flat bottom surface of the water collection tank of the base 22 and the slow flow speed of water can be prevented. In one embodiment, the cleaning chamber 102 further has the recessed space 183 formed therein, allowing the cleaning liquid carrying dust or dirt in the mopping cloth 16 to even more easily flow into the recessed space 183 and be collected in the waste-water tank 42. In one embodiment, the bottom and the sidewall of the chamber body 108 form an enclosed space as a water collection structure, and are capable of blocking the cleaning liquid from flowing out from the bottom or the sidewall of the chamber body 108 and hence preventing spillage of the cleaning liquid, so that dust or dirt accumulated on the bottom surface of the water collection tank of the base 22 can be reduced.

The structures of several specific embodiments are described as above for a person skilled in the art to better understand the various aspects of the present disclosure. It is to be understood by a person skilled in the art that, the present disclosure may be used as designs or modification for implementing other processes and structural basis for achieving the same objects and/or the same advantages as those of the embodiments described in the literature. Moreover, it is also to be understood by a person skilled in the art that, these equivalent structures do not depart from the spirit and scope of the disclosure, and various changes, modifications and substitutions may also be made to the details of the literature without departing from the spirit and scope of the present disclosure.

What is claimed is:

1. A cleaning device for cleaning a mopping cloth of a self-propelled cleaning apparatus, the cleaning device comprising:
a clean-water tank, for storing a cleaning liquid;
a waste-water tank;
a base;
a cleaning unit, configured to be movable along a first direction at the base, the cleaning unit comprising:
a water outlet, configured to spray the cleaning liquid in a direction away from the base;
at least one cleaning bush; and
a cleaning chamber, exposing at least one portion of the at least one cleaning brush, for the at least one cleaning brush to clean the mopping cloth;
a clean-water pipeline, communicating between the clean-water tank and the water outlet, for the cleaning liquid in the clean-water tank to pass through the clean-water pipeline and be sprayed from the water outlet; and
a waste-water pipeline, communicating between the waste-water tank and the cleaning chamber of the cleaning unit, for the cleaning liquid sprayed while the cleaning unit cleans the mopping cloth to pass through the waste-water pipeline and be collected in the waste-water tank.

2. The cleaning device according to claim 1, wherein a bottom and a sidewall of the cleaning chamber form a separation space, which is configured to block the cleaning liquid from flowing out from the bottom or the sidewall of the cleaning chamber.

3. The cleaning device according to claim 2, wherein the bottom of the cleaning chamber is provided with a drainage hole, which communicates with the waste-water pipeline and is configured to discharge the cleaning liquid.

4. The cleaning device according to claim 3, wherein the bottom of the cleaning chamber is defined with a recessed space, and the drainage hole is located in the recessed space.

5. The cleaning device according to claim 4, wherein
the drainage hole is located on a lowermost position of the cleaning chamber,
a part of the clean-water pipeline connected to the water outlet moves along with a movement of the cleaning unit, and
a part of the waste-water pipeline connected to the cleaning chamber moves along with the movement of the cleaning unit.

6. The cleaning device according to claim 4, wherein the bottom of the cleaning chamber further comprises at least one side inclined surface and a bottom inclined surface, the at least one side inclined surface and the bottom inclined surface define the recessed space, the bottom inclined surface comprises a first side and a second side opposite to the first side, the first side of the bottom inclined surface is connected to the drainage hole, the bottom inclined surface is configured to extend downward from the second side to the first side, and a width of the second side of the bottom inclined surface is greater than a width of the first side of the bottom inclined surface.

7. The cleaning device according to claim 6, wherein
the at least one cleaning brush comprises at least one roller brush, the at least one roller brush comprises a cleaning section and a brush handle for supporting the cleaning section,
at least one portion of the at least one cleaning bush exposed by the cleaning chamber comprises the cleaning section,
the cleaning unit further comprises a drive section, the drive section is configured to drive the at least one roller brush to rotate around a second direction as an axis, and the second direction is different form the first direction.

8. The cleaning device according to claim 7, wherein a ratio of a length of the cleaning section to a length of the at least one roller brush is less than 1:2.

9. The cleaning device according to claim 7, wherein the drive section comprises a first drive element and a second drive element, wherein the first drive element is for moving the cleaning unit along the first direction, and the second drive element is for rotating the at least one roller brush.

10. The cleaning device according to claim 9, wherein
the at least one roller brush comprises a first roller brush and a second roller brush,
the water outlet is located between the first roller brush and the second roller brush, and
the first roller brush and the second roller brush rotate in opposite directions.

11. The cleaning device according to claim 10, wherein the bottom of the cleaning chamber further comprises a spacer plate, the spacer plate extends upward from a surface of the bottom inclined surface and is for separating the first roller brush and the second roller brush.

12. The cleaning device according to claim 1, further comprising:
a waste-water motor, configured to provide a drive force for the cleaning liquid sprayed while the cleaning unit cleans the mopping cloth to pass through the waste-water pipeline and be collected in the waste-water tank; and
a rack, arranged on the base and extending along the first direction;
wherein the cleaning unit further comprises: a drive section, neighboring to the base and connected to the rack, and the drive section configured to move the cleaning unit along the first direction on the rack.

13. The cleaning device according to claim 1, further comprising:
a waste-water motor, communicating with the waste-water tank, the waste-water motor for forming a negative pressure in the waste-water tank, such that the cleaning liquid sprayed while the cleaning unit cleans the mopping cloth passes through the waste-water pipeline and is collected in the waste-water tank.
